(19) United States
(12) Patent Application Publication
(10) Pub. No.: US 2007/0281250 A1
(43) Pub. Date: Dec. 6, 2007

(54) Electrophotographic image-receiving sheet and process for image formation using the same

(75) Inventor: Toshiaki Aono, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/701,390

(22) Filed: Feb. 2, 2007

Related U.S. Application Data
(62) Division of application No. 10/437,383, filed on May 14, 2003, now abandoned.

(30) Foreign Application Priority Data
May 15, 2002 (JP) 2002-140529

(51) Int. Cl. G03C 5/00

(52) U.S. Cl. 430/330

(57) ABSTRACT

The electrophotographic image-receiving sheet includes a support and a toner image-receiving layer which contains a thermoplastic resin and is disposed on the support, in which a surface of the toner image-receiving layer has a glossiness by specular reflection of 20 or less before image formation at an angle of incidence of 20°, the surface has the glossiness of 50 or more after image formation at an angle of incidence of 20°, and an opposite surface of the support to a surface on which the toner image-receiving layer is disposed has a surface roughness of 0.5 μm or more. A process for image formation includes the steps of forming a toner image on a surface of the electrophotographic image-receiving sheet, heating and pressurizing the surface by a fixing belt and a fixing roller and cooling the surface so as to separate the electrophotographic image-receiving sheet from the fixing belt.

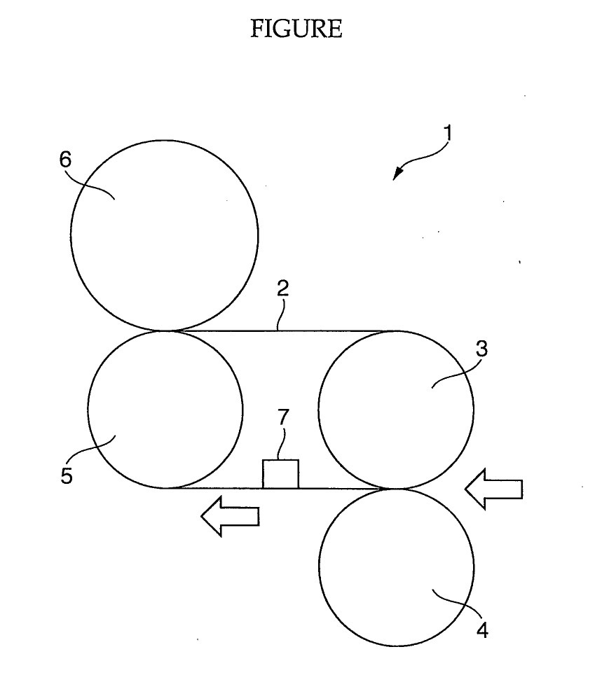

### BACKGROUND OF THE INVENTION

1. Field of the Invention

The present invention relates to an electrophotographic image-receiving sheet and to a process for image formation. More specifically, it relates to an electrophotographic image-receiving sheet which shows excellent smoothness (glossiness), can be used in copying machines, printers, facsimile machines, and other apparatus using electrophotographic processes, does not induce adhesion between sheets or blocking when plural piles of the electrophotographic image-receiving sheets are disposed together while stored, and shows excellent comprehensive evaluation results including good transporting properties and high image quality. It also relates to a process for image formation using the electrophotographic image-receiving sheet.

2. Description of the Related Art

Electrophotography is a dry process, can print at a high speed, can produce an output on general purpose paper such as plan paper and woodfree paper and is thereby be used in output systems of copying machines and personal computers. However, this technique requires paper exclusively for photography when image information such as of faces and landscapes is output as a photograph, since such general purpose paper has insufficient glossiness. To improve glossiness, Japanese Patent Application Laid-Open (JP-A) No. 04-212168 and JP-A No. 08-211645 each disclose an electrophotographic image-receiving sheet having a toner image-receiving layer that contains a thermoplastic resin on a support.

However, such an electrophotographic image-receiving sheet having high glossiness often invites adhesion between sheets such as “blocking,” since they are designed to improve thermal response of the toner image-receiving layer at low temperatures and to improve fixing properties. The thermal response is a phenomenon that the toner image-receiving layer is sharply melted or softened due to heat for fixing an image. When the electrophotographic image-receiving sheet is stacked in plural plies or is rolled during storage, the support of an electrophotographic image-receiving sheet comes into contact with the toner image-receiving layer of the electrophotographic image-receiving layer or of another electrophotographic image-receiving sheet lying therebelow to thereby invite adhesion between sheets or contact trouble. Once such adhesion between sheets occurs, sheet-feed paper cannot be fed or transported, and roll-feed paper invites flake off of the toner image-receiving layer from the support when the paper is dragged out.

### SUMMARY OF THE INVENTION

It is therefore an object of the present invention to provide an electrophotographic image-receiving sheet which has excellent smoothness (glossiness), can be used for photography, does not invite adhesion between sheets and blocking, when plural plies thereof are stacked while stored, and shows excellent comprehensive evaluation results including good transporting properties and high image quality.

It is another object of the present invention to provide a process for image formation using the electrophotographic image-receiving sheet.

The present invention therefore provides, in an aspect, an electrophotographic image-receiving sheet which comprises a support, and a toner image-receiving layer which contains a thermoplastic resin and is disposed on the support. In the electrophotographic image-receiving sheet of the present invention, a surface of the toner image-receiving layer has a glossiness by specular reflection of 20 or less before image formation at an angle of incidence of 20° between the electrophotographic image-receiving sheet and the incident light, and the surface has a glossiness by specular reflection of 50 or more after image formation at an angle of incidence of 20° between the electrophotographic image-receiving sheet and the incident light. The electrophotographic image-receiving sheet satisfies the requirement that a surface of the toner image-receiving layer has a glossiness by specular reflection of 20 or less before image formation at an angle of incidence of 20° between the electrophotographic image-receiving sheet and the incident light, the surface has a glossiness by specular reflection of 50 or more after image formation at an angle of incidence of 20° between the electrophotographic image-receiving sheet and the incident light. The electrophotographic image-receiving sheet can thereby prevent at least one of adhesion and blocking between stacked plural plies thereof during storage, has excellent smoothness (glossiness) after image formation and can be advantageously used for photography.

The present invention provides, in another aspect, a process for image formation which comprises the step of forming a toner image on a surface of an electrophotographic image-receiving sheet, the step of heating and pressurizing the surface by a fixing belt and a fixing roller, and the step of cooling the surface so as to separate the electrophotographic image-receiving sheet from the fixing belt. The process for image formation of the present invention utilizes an electrophotographic image-receiving sheet according to the present invention. Thus, the releasability of the electrophotographic image-receiving sheet and the toner can be improved, offset of the electrophotographic image-receiving sheet and the toner can be prevented, the paper can thereby be fed stably, and the resulting images are good, have sufficient glossiness to a degree not conventionally attained and have excellent photographic texture.

### BRIEF DESCRIPTION OF THE DRAWING

FIGURE is a schematic diagram illustrating a fixing belt system in a printer used in examples.

### DESCRIPTION OF THE PREFERRED EMBODIMENTS

(Electrophotographic Image-receiving Sheet)

The electrophotographic image-receiving sheet of the present invention comprises a support and at least a toner image-receiving layer comprising a thermoplastic resin and being disposed on the support. It may further comprise one or more of the layers appropriately selected according to necessity. Examples of the layers include a surface protective layer, an intermediate layer, an undercoat, a cushioning layer, a charge-control (antistatic) layer, a reflective layer, a color-tint layer, a storage-stability improving layer, an anticurl layer, a smoothing layer, and the like. Each of these layers may have a single layer structure or a multiplayer structure.

In the present invention, a surface of the toner image-receiving layer before image formation has a glossiness of 20 or less, and preferably 15 or less, and more preferably 10 or less. If the glossiness of the surface of the toner image-receiving layer before image formation is more than 20, adhesion between sheets or blocking may occur when plural plies of the electrophotographic image-receiving sheet are stored, so that the upper surfaces of the electrophotographic image-receiving sheets are overlaid, or the upper surface and the back surface of the electrophotographic image-receiving sheets are overlaid. The trouble may particularly occur when the upper surfaces of the electrophotographic image-receiving sheets are overlaid with each other.

In addition, the surface after image formation has a glossiness of 50 or more, preferably 60 or more, and more preferably 65 or more, at an angle of incidence of 20° between the electrophotographic image-receiving sheet and incident light. If the glossiness of the surface after image formation is less than 50, the resulting image has low quality. The process for image formation will be described in detail hereinafter. In the present invention, the term, “after image formation” refers to “after fixing a toner image,” where a toner image is formed on the toner image-receiving layer of an electrophotographic image-receiving sheet and is fixed thereon.

The glossiness can be determined according to a method described in Japanese Industrial Standards JIS) Z 8741.

The above-specified gloss on the surface of the electrophotographic image-receiving sheet before and after image formation can be achieved by any means appropriately selected. For example, the following conditions (1) to (5) can be employed in a suitable combination.
(1) Adjusting the type of the support (e.g., a paper support or synthetic paper support), and the amount of a sizing agent.
(2) Controlling the glass transition temperature (Tg), MFT, size and amount of latex used in surface coat layers (the toner image-receiving layer and its auxiliary layers).
(3) Using aggregation due to the glass transition temperature (Tg) of a binder (of the toner image-receiving layer and its auxiliary layers), phase separation of the binder, and interaction with another material.
(4) Controlling the glass transition temperature (Tg), melting point, size, and amount of organic and inorganic fine particles (a matting agent).
(5) Controlling the heating temperature, heating time, cooling and peeling (separating) procedure (e.g., using belt fixing or ferrotype fixing) in a heat fixing process.

The electrophotographic image-receiving sheet of the present invention has a surface roughness (Ra) of preferably 0.5 μm or more, and more preferably 1 μm or more, on an opposite surface of the support (for example, a back surface of the support, a surface of a backing layer, or the like) to a surface of the support on which the toner image-receiving layer is disposed. If the surface roughness is less than 0.5 μm, when the toner image-receiving layer and the opposite surface are brought into contact while sequentially disposing the electrophotographic image-receiving sheets, or while storing the electrophotographic image-receiving sheet in rolled, the electrophotographic image-receiving sheet may cause adhesion trouble such as blocking or the like.

The electrophotographic image-receiving sheet of the present invention may further comprise a backing layer on a surface (back surface) of the support opposite to the surface on which the toner image-receiving layer is disposed. The backing layer is disposed in order to enable the back surface to receive an image, to improve the quality of the image formed on the back surface, to improve curling balance, to impart writability to the sheet, to enable the sheet to be printed by ink-jet printing or other printing procedure, to enable the sheet to be sufficiently transported in an apparatus, or the like.

A surface roughness of the backing layer is preferably 0.5 μm or more, and more preferably 1.0 μm or more.

The surface roughness can be measured according to JIS B 0601, B 0651, and B 0652.

The backing layer may have the same configuration as the toner image-receiving layer in order to enable the both surfaces to receive or to form images more sufficiently. The backing layer may further comprise various additives. Of those, pigments, matting agents, lubricants, charge control agents, and other additives as in the toner image-receiving layer are preferably used. The backing layer can have a single layer structure or a multi-layer structure.

When releasing oil is used in a fixing roller and other members to prevent offset during fixing an image, the back surface or the backing layer is preferably capable of absorbing oil.

Each of the components of the electrophotographic image-receiving sheet of the present invention will be described in detail hereinafter.

[Support]

The support of the electrophotographic image-receiving sheet is not specifically limited and can be appropriately selected according to an intended purpose, as long as it can endure at fixing temperature and can satisfy requirements in smoothness, whiteness, slidability, frictionality, antistatic properties, and depressions after fixing an image. Examples of the support include photographic supports such as paper and synthetic polymers (films) as described in Basis of Photographic Technology-silver halide photography edited by The Society of Photographic Science and Technology of Japan, Corona Publishing Co., Ltd., pp. 223-240 (1979), and the like.

Specific examples of the support include synthetic paper (synthetic paper made from, for example, polyolefins or polystyrenes), woodfree paper, art paper, (double-side) coated paper, (double-side) cast coat paper, mixed paper made from polyethylene or other synthetic resin pulp and natural pulp; Yankee paper, baryta paper, wallpaper, backing paper, synthetic resin- or emulsion-impregnated paper, synthetic rubber latex-impregnated paper, paper having a synthetic resin as an internal additive, paperboard, cellulosic fiber paper, polyolefin-coated paper (of which double-sided polyethylene-coated paper is preferred), or the like; films and sheets of plastics or polymers such as polyolefins, poly(vinyl chloride), poly(ethylene terephthalate), poly(styrene methacrylate), poly(ethylene naphthalate), polycarbonate-poly(vinyl chloride), polystyrene, polypropylenes, polyimide, celuloses such as triacetylcellulose; films and sheets obtained by subjecting these plastic films and sheets to a treatment, such as addition of a pigment such as titanium oxide for imparting white-reflecting properties; fabrics; metals, and glass.

Each of these supports can be used alone or in combination as a multilayer. One or both surfaces of the support may be laminated with a synthetic polymer such as polyethylene or the like.

Examples of the support can also be found in JP-A No. 62-253159 (pp. 29-31 in Japanese), JP-A No. 01-61236 (pp. 14-17 in Japanese), JP-A No. 63-316848, JP-A No. 02-22651, JP-A No. 03-56955, and the U.S. Pat. No. 5,001,033, and the like.

The thickness of the support is preferably 25 μm to 300 μm, more preferably 50 μm to 260 μm, and still more preferably 75 μm to 220 μm.

The stiffness (rigidity) and smoothness of the support are not specifically limited, can be appropriately selected according to an intended purpose and are preferably near to those in supports for use in color silver halide photography when the sheet is used as an electrophotographic image-receiving sheet of photographic texture.

The density of the support is preferably 0.7 g/cm³ or more from a viewpoint of better fixing properties.

The thermal conductivity of the support is not specifically limited, can be appropriately selected according to an intended purpose. The thermal conductivity of the support is preferably 0.50 kcal/m·h·° C. at a temperature of 20° C. and under a relative humidity of 65%.

The thermal conductivity can be measured, for example, by conditioning a transfer paper according to JIS P 8111 and determining the thermal conductivity of the conditioned transfer paper according to a procedure described in JP-A No. 53-66279.

The support may further comprise various additives appropriately selected according to an intended purpose, as long as it does not adversely affect the advantages of the present invention.

Examples of the additives include a brightening agent (whitening agents), a conductive agent, a filler, and pigments and dyes such as titanium oxide, ultramarine blue, carbon black, and the like.

The support may be subjected to at least one of surface treatments and primary coatings at one or both surfaces thereof to thereby improve contact with other layer disposed on the support.

Examples of the surface treatments include activation treatments such as embossing or printing to form a glossy surface, a fine surface described in JP-A No. 55-26507, a matt surface or a tweed surface, corona discharge treatment, glow discharge treatment, plasma treatment, and the like.

The undercoating treatments can be any known undercoating treatment.

Each of these treatments can be employed either alone or in combination of two or more. For example, the support is subjected to the embossing and then to the activation treatment. It may be further subjected to the undercoating treatment after a surface treatment such as the activation treatment.

The support may be coated with a hydrophilic binder, a semiconductive metal oxide such as alumina sol or tin oxide, and an antistatic agent such as carbon black on at least one of its upper surface and back surface. Typical disclosure of these coated supports can be found in, for example, JP-A No. 63-220246.

[Toner Image-receiving Layer]

The toner image-receiving layer receives at least one of color toners and black toners to thereby form an image.

Materials for the toner image-receiving layer are not specifically limited, can be appropriately selected according to an intended purpose. Examples of the materials for the toner image-receiving layer include image-receiving substances that can receive a toner for the formation of images from a development drum or an intermediate image transfer medium by action of (static) electricity or pressure in a transferring step and can be fixed by action of, for example, heat or pressure in a fixing step.

Examples of the image-receiving substances include thermoplastic resins, aqueous resins, pigments, and the like.

The thickness of the toner image-receiving layer is preferably from 0.5 μm to 50 μm in general, and more preferably from 3 μm to 30 μm. The thickness is preferably one second or more, and preferably 1 to 3 times as large as the average particle diameter of the toners.

The toner image-receiving layer satisfies preferably one or more, more preferably two or more, and still more preferably all of the following requirements in its physical properties.

(1) The glass transition temperature (Tg) of the toner image-receiving layer is preferably 30° C. or higher and is a glass transition temperature of the toner plus 20° C. or lower.

(2) The softening point (T1/2) of the toner image-receiving layer as measured by the 1/2 method is preferably 60° C. to 200° C., and more preferably 80° C. to 170° C. The softening point as determined by the 1/2 method is measured in the following manner. A sample is preheated at an initially setting temperature (e.g., 50° C.) for a predetermined time (e.g., 300 seconds) and is then heated at a set constant heating rate using a specific apparatus under specific conditions at a set extrusion load. The softening point (T 1/2) is defined as a temperature such that the difference of piston stroke between the starting and completion of flowing becomes one second.

(3) Tfb (flow beginning temperature) of the toner image-receiving layer is preferably 40° C. to 200° C., and a Tfb of the toner image-receiving layer is a Tfb of the toner plus 50° C. or lower.

(4) A temperature at which the viscosity of the toner image-receiving layer becomes 1×10⁵ cP is preferably 40° C. or higher and is preferably lower than that of the toner.

(5) The storage modulus (G′) of the toner image-receiving layer is preferably from 1×10² Pa to 1×10⁵ Pa and the loss modulus (G″) thereof is preferably from 1×10² Pa to 1×10⁵ Pa at a fixing temperature.

(6) The loss tangent (G″/G′) as the ratio of the loss modulus (G″) to the storage modulus (G′) of the toner image-receiving layer at a fixing temperature is preferably 0.01 to 10.

(7) The storage modulus (G′) of the toner image-receiving layer at a fixing temperature preferably is minus 50 to plus 2500 of the loss modulus (G″) of the toner at a fixing temperature.

(8) A melted toner forms an inclination with the toner image-receiving layer of preferably 50° or less and more preferably 40° or less.

The toner image-receiving layer is preferably any of those which satisfy physical properties disclosed in, for example, Japanese Patent No. 2788358, JP-A No. 07-248637, No. 08-305067, and No. 10-239889.

The physical property (1), Tg, can be measured using a differential scanning calorimeter (DSC). The physical properties (2) and (3) can be measured by using, for example, a Flow Tester CFT-500 (available from Shimadzu Corporation). The physical properties (5), (6) and (7), storage modulus (G′), loss modulus (G″) and loss tangent (G″/G′), can be measured by using, for example, a rotary rheometer such as Dynamic Analyzer RAD II (available from Rheometrics, Inc.). The physical property (8), angle of inclination, can be measured using a contact angle meter available from Kyowa Kaimen Kagaku Co., Ltd. according to a process disclosed in JP-A No. 08-334916.

--Thermoplastic Resin--

The thermoplastic resin for use in the present invention are not specifically limited as long as they can deform at temperatures during, for example, fixing and can receive the toner. The thermoplastic resin can be appropriately selected according to an intended purpose and are preferably similar or the same resin as the binder resin of the toner. Copolymer resins such as a polyester resin, a styrene resin, styrene-butyl acrylate, or the like are often used in most of the toners. The electrophotographic image-receiving sheet preferably comprise any of these polyester resins, styrene resins, styrene-butyl acrylate, or the like more preferably in an amount of 20% by mass or more. As the thermoplastic resins, styrene-acrylic ester copolymers, styrene-methacrylic ester copolymers, and the like are also preferred.

Examples of the thermoplastic resin include (a) a resin having an ester bond, (b) a polyurethane resin, or the like (c) a polyamide resin or the like, (d) a polysulfone resin or the like, (e) a poly(vinyl chloride) resin or the like, (f) a poly(vinyl butyral) or the like, (g) a polycaprolactone resin or the like, and (h) a polyolefin resin or the like.

Examples of the (a) a resin having an ester bond include polyester resins obtained by condensation of a dicarboxylic acid component with an alcohol component. Examples of the dicarboxylic acid component include terephthalic acid, isophthalic acid, maleic acid, fumaric acid, phthalic acid, adipic acid, sebacic acid, azelaic acid, abietic acid, succinic acid, trimellitic acid, pyromellitic acid, and the like. Each of these dicarboxylic acid components may be substituted with a sulfonic acid group, a carboxyl group, or the like. Examples of the alcohol component include ethylene glycol, diethylene glycol, propylene glycol, bisphenol A, diether derivatives of bisphenol A (e.g., an ethylene oxide diadduct of bisphenol A, and a propylene oxide diadduct of bisphenol A), bisphenol S, 2-ethylcyclohexyldimethanol, neopentyl glycol, cyclohexyldimethanol, glycerol, and the like. Each of these alcohol components may be substituted with a hydroxyl group, or the like. The examples of the resins (a) also include a polyacryic ester resins and polymethacrylic ester resin such as poly(methyl methacrylate), poly(butyl methacrylate), poly(methyl acrylate), poly(butyl acrylate), or the like, a polycarbonate resin, a poly(vinyl acetate) resin, a styrene-acrylate resin, a styrene-methacrylate copolymer resin, a vinyltoluene-acrylate resin, and the like. The examples of the (a) can be found in, for example, JP-A No. 59-101395, JP-A No. 63-7971, JP-A No. 63-7972, JP-A No. 63-7973, and JP-A No. 60-294862, or the like.

Commercial products of the polyester resin include under the trade name of Vylon 290, Vylon 200, Vylon 280, Vylon 300, Vylon 103, Vylon GK-140, and Vylon GK-130 from Toyobo Co., Ltd.; Tuftone NE-382, Tuftone U-5, ATR-2009, and ATR-2010 from Kao Corporation; Elitel UE 3500, UE 3210, and XA-8153 from Unitika Ltd.; and Polyestar TP-220, and R-188 from Nippon Synthetic Chemical Industry Co., Ltd. Commercial products of the acrylic resins are under the trade names of Dianal SE-5437, SE-5102, SE-5377, SE-5649, SE-5466, SE-5482, HR-169, HR-124, HR-1127, HR-116, HR-113, HR-148, HR-131, HR470, HR-634, HR-606, HR-607, LR-1065, LR-574, LR-143, LR-396, LR-637, LR-162, LR-469, LR-216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, and BR-117 from Mitsubishi Rayon Co., Ltd.; Eslec P SE-0020, SE-0040, SE-0070, SE-0100, SE-1010, and SE-1035 from Sekisui Chemical Co., Ltd.; Himer ST 95, and ST 120 from Sanyo Chemical Industries, Ltd.; and FM 601 from Mitsui Chemicals, Inc.

Examples of the (e) poly(vinyl chloride) resin or the like include a poly(vinylidene chloride) resin, a vinyl chloride-vinyl acetate copolymer resin, a vinyl chloride-vinyl propionate copolymer resin, and the like.

Examples of the (f) poly(vinyl butyral) or the like include a polyol resin, an ethylcellulose resin, a cellulose acetate resin, and the like. Commercial products of the (f) poly(vinyl butyral) include those produced by Denki Kagaku Kogyo Kabushiki Kaisha and those produced by Sekisui Chemical Co., Ltd. The poly(vinyl butyral) for use herein preferably comprises vinyl butyral in a content of 70% by mass or more and has an average polymerization degree of preferably 500 or more, and more preferably 1000 or more. Commercial products of the (f) poly(vinyl butyral) include, under the trade names of, Denka Butyral 3000-1, 4000-2, 5000A, and 6000C from Denki Kagaku Kogyo Kabushiki Kaisha; and Eslec BL-1, BL-2, BL-3, BL-S, BX-L, BM-1, BM-2, BM-5, BM-S, BH-3, BX-1, and BX-7 from Sekisui Chemical Co., Ltd.

Examples of the (g) polycaprolactone resins or the like further include a styrene-maleic anhydride resin, a polyacrylonitrile resin, a polyether resin, an epoxy resin, a phenol resin, and the like.

Examples of the (h) polyolefin resins or the like include a polyethylene resin, a polypropylene resin, copolymer resins of an olefin such as ethylene or propylene with another vinyl monomer, an acrylic resin, and the like.

Each of these thermoplastic resins can be used either alone or in combination of two or more. Mixtures of these thermoplastic resins and copolymers thereof can also be used.

The thermoplastic resin preferably satisfies the requirements in the physical properties of a toner image-receiving layer which contains the thermoplastic resin, and more preferably satisfies the requirements alone. It is also preferred that two or more resins exhibiting different physical properties as the toner image-receiving layer are used in combination.

The thermoplastic resin preferably has a larger molecular weight than that of a thermoplastic resin in the toner. However, this relationship in molecular weight between two thermoplastic resins may not be applied to some cases. For example, when the thermoplastic resin used in the toner image-receiving layer has a softening point higher than that of the thermoplastic resin used in the toner, the thermoplastic resin in the toner image-receiving layer may preferably have a molecular weight equivalent to or lower than that of the thermoplastic resin in the toner.

A mixture of resins having the same composition but different average molecular weights is also preferably used as the thermoplastic resin. The preferable relationship in molecular weight between the thermoplastic resin used in the toner image-receiving layer and that used in the toner is disclosed in JP-A No. 08-334915.

The thermoplastic resin preferably has a larger particle size distribution than that of the thermoplastic resin used in the toner.

The thermoplastic resin preferably satisfies the requirements in physical properties as disclosed in, for example, JP-A No. 05-127413, No. 08-194394, No. 08-334915, No. 08-334916, No. 09-171265, and No. 10-221877.

Aqueous Resin

The aqueous resin is not specifically limited in their compositions, bonding configurations, molecular structures, molecular weights, molecular weight distributions, shapes, and other factors and can be appropriately selected according to an intended purpose, as long as they are water-soluble or water-dispersible resins.

Typical disclosure of the aqueous resins can be found in, for example, Research Disclosure No. 17,643, p. 26; Research Disclosure No. 18,716, p. 651; Research Disclosure No. 307,105, pp. 873-874; and JP-A No. 64-13546, pp. 71-75 (in Japanese). Examples of the aqueous resin include vinylpyrrolidone-vinyl acetate copolymer, styrene-vinylpyrrolidone copolymers, styrene-maleic anhydride copolymer, water-soluble polyester, water-soluble polyurethane, water-soluble nylons (water-soluble polyamides), water-soluble an epoxy resin.

For example, when the binder resin of the toner is a polyester resin, a water-dispersible polyester can be preferably used as the resin in the toner image-receiving layer.

Examples of the water-dispersible resin include latex emulsions of an acrylic resin, a polyester resin, a polystyrene resin, an urethane resin, poly(vinyl acetate), styrene-butadiene rubber (SBR), copolymers and blends of these resins.

Each of these resins can be used either alone or in combination of two or more.

Commercial products of the water-dispersible resin include, under the trade names of, Vylonal MD-1200, MD-1220, and MD-1930 from Toyobo Co., Ltd.; Pluscoat Z-446, Z465, and RZ-96 from Goo Chemical Co., Ltd.; Finetex ES-611 and ES-670 from Dainippon Ink & Chemicals Inc.; Pesresin A-160P, A-210, and A-620 from Takamatsu Oil & Fat Co., Ltd.; Hiros XE-18, XE-35, XE48, XE-60, and XE-62 from Seiko Chemical Industries Co., Ltd.; and Jurymer AT-210, AT-510, AT-515, AT-613, ET410, ET-530, ET-533, FC-60, and FC-80 from Nihon Junyaku Co., Ltd, and the like.

Gelatin can also be preferably used as the water-soluble resin. The gelatin can be appropriately selected according to an intended purpose from among limed gelatin, acid-treated gelatin, and “decalcified gelatin” having a reduced content of calcium. Each of the gelatin can be used either alone or in combination of two or more.

A film of the water-dispersible resin is preferably formed at a room temperature or more, from a view point of sufficient storage before printing, and is preferably formed at 100° C. or lower from a viewpoint of sufficient fixing of the toners.

Pigments

The pigments can be used as materials of the toner image-receiving layer for imparting whiteness and/or for controlling thermodynamic properties of the toner image-receiving layer.

Preferable examples of the pigments include inorganic pigments, organic pigments, fluorescent whitening agents, dyes, and the like.

Examples of the inorganic pigments include silica pigments, alumina pigments, titanium oxide pigments, zinc oxide pigments, zirconium oxide pigments, micaceous iron oxide, white lead, lead oxide pigments, cobalt oxide pigments, strontium chromate, molybdenum pigments, smectite, magnesium oxide pigments, calcium oxide pigments, calcium carbonate pigments, barium sulfate pigments, mullite, and the like. Of these, silica pigments, titanium oxide pigments, and alumina pigments are preferred. Each of these inorganic pigments can be used either alone or in combination of two or more.

Examples of the silica pigments include spherical silica, amorphous silica, and the like.

The silica pigments can be prepared by a dry process, a wet process or an aerosol process. Alternatively, the silica pigments can be prepared by treating the surface of hydrophobic silica particles with trimethylsilyl groups or silicone. Of these, colloidal silica is preferred as the silica pigment.

The silica pigments preferably have an average particle diameter of 200 nm to 5000 nm for imparting whiteness, while the preferred range thereof may vary according to an intended purpose.

The silica pigment is preferably a porous silica pigment. The porous silica pigment has an average pore size of preferably 4 nm to 120 nm, and more preferably 4 nm to 90 nm. An average pore volume per mass of the porous silica is preferably 0.5 ml/g to 3 ml/g.

The alumina pigments include anhydrous alumina and alumina hydrates. The anhydrous alumina may have a crystal form of α, β, γ, δ, ζ, η, θ, κ, ρ, or χ. The alumina hydrates are more preferable than the anhydrous alumina. The alumina hydrates can be alumina monohydrates or alumina trihydrates. The monohydrates include pseudoboehmite, boehmite, diaspore, and the like. The trihydrates include gibbsite and bayerite.

The alumina pigments have an average particle diameter of preferably 4 nm to 5000 nm, and more preferably from 200 nm to 5000 nm for imparting whiteness.

The alumina pigments are preferably porous alumina.

The alumina hydrates can be prepared by a sol-gel method in which ammonia is added to an aluminium salt solution to thereby precipitate an alumina hydrate, or by a process of hydrolyzing a basic aluminate. The anhydrous alumina can be prepared by dehydrating an alumina hydrate by heating.

The amount of inorganic pigment is preferably from 5 parts by mass to 500 parts by mass on dry mass basis relative to 100 parts by mass of a binder in the toner image-receiving layer.

Preferable examples of the organic pigments include porous particles, aggregated particles of fine particles, hollow particles, and the like.

The porous particles preferably have an average particle diameter of from 1 nm to 100 nm. Commercial products of the porous particles include, under the trade names of, Techpolymer MBP-8, Techpolymer SBP-8, Apanicron AP-20C, and Poraslen from Sekisui Plastics Co., Ltd.

The aggregated particles of fine particles are aggregated particles each comprising fine particles having a particle diameter of from 1 nm to 100 nm. The average particle diameter of the aggregated particles is preferably 100 nm to 2000 nm, and more preferably from 200 nm to 1000 nm. Commercial products of the aggregated particles include, under the trade name of, Organic Filler SUBMICRON FILLER from Nippon Kasei Chemical Co., Ltd.

The hollow particles have an average particle diameter of preferably from 100 nm to 2000 nm and more preferably from 200 nm to 1000 nm. Commercial products of the hollow particles include, under trade name of, Nipol MH 5055 from Zeon Corporation.

The fluorescent whitening agents can be any of known compounds that have absorption in near-UV regions and emit fluorescence at 400 nm to 500 nm.

Typical disclosure of the fluorescent whitening agents can be found in, for example, K. Venkataraman (Ed.) The Chemistry of Synthetic Dyes Vol. V, 8, Academic Press, NY (1971). Examples of the fluorescence brightening agents include stilbene compounds, coumarin compounds, biphenyl compounds, benzoxazoline compounds, naphthalimide compounds, pyrazoline compounds, carbostyril compounds, and the like. Commercial products of the fluorescent whitening agents include, under the trade names of, Whitex PSN, PHR, HCS, PCS and B from Sumitomo Chemical Co., Ltd.; and UVITEX-OB from Ciba Geigy Ltd.

The dyes can be any of conventional water-soluble and/or oil-soluble dyes.

Examples of the oil-soluble dyes include anthraquinone compounds, azo compounds, and the like.

Specific examples of the oil-soluble dyes include vat dyes such as C. I. Vat Violet 1, C. I. Vat Violet 2, C. I. Vat Violet 9, C. I. Vat Violet 13, C. I. Vat Violet 21, C. I. Vat Blue 1, C. I. Vat Blue 3, C. I. Vat Blue 4, C. I. Vat Blue 6, C. I. Vat Blue 14, C. I. Vat Blue 20, C. I. Vat Blue 35, or the like; disperse dyes such as C. I. Disperse Violet 1, C. I. Disperse Violet 4, C. I. Disperse Violet 10, C. I. Disperse Blue 3, C. I. Disperse Blue 7, C. I. Disperse Blue 58, or the like; C. I. Solvent Violet 13, C. I. Solvent Violet 14, C. I. Solvent Violet 21, C. I. Solvent Violet 27, C. I. Solvent Blue 11, C. I. Solvent Blue 12, C. I. Solvent Blue 25, C. I. Solvent blue 55, and the like. Colored couplers for use in silver halide photography are also preferred.

Other Additives

The toner image-receiving layer may further comprise other additives appropriately selected for improving its thermodynamic properties.

The other additives are not specifically limited, can be appropriately selected according to an intended purpose. Examples of the other additives include plasticizers, fillers, crosslinking agents, charge control agents, conductive agents, surfactants, humidifying agents, matting agents, and the like.

Plasticizers

The plasticizers can be any of known plasticizers for resins. The term, “plasticizers,” means and includes a group of compounds for controlling fluidizing or softening of the toner image-receiving layer by action of heat and/or pressure when the toner is fixed.

Examples of the plasticizers can be found in Kagaku Binran (Chemical Handbook), ed. by The Chemical Society of Japan, Maruzen Co., Ltd. Tokyo; Plasticizer, Theory and Application, edited and written by Koichi Murai and published by Saiwai Shobo; Volumes 1 and 2 of Studies on Plasticizer, edited by Polymer Chemistry Association; and Handbook on Compounding Ingredients for Rubbers and Plastics, edited by Rubber Digest Co. Suitable materials include, for example, esters disclosed in JP-A No. 59-83154, No. 59-178451, No. 59-178453, No. 59-178454, No. 59-178455, No. 59-178457, No. 62-174754, No. 62-245253, No. 61-209444, No. 61-200538, No. 62-8145, No. 62-9348, No. 62-30247, No. 62-136646, No. 62-174754, No. 62-245253, No. 61-209444, No. 61-200538, No. 62-8145, No. 62-9348, No. 62-30247, No. 62-136646, and No. 02-235694 such as phthalic acid ester, phosphoric acid ester, fatty acid ester, abietic acid ester, adipic acid ester, sebacic acid ester, azelaic acid ester, benzoic acid ester, butyric acid ester, epoxidized fatty acid ester, glycolic acid ester, propionic acid ester, trimellitic acid ester, citric acid ester, sulfonic acid ester, carboxylic acid ester, succinic acid ester, maleic acid ester, fumaric acid ester, phthalic acid ester, stearic acid ester, or the like; amides such as aliphatic amide, sulfonamides, or the like; ethers, alcohols, paraffins, polyolefin wax such as polypropylene wax and polyethylene wax, lactones, poly (ethylene oxide), silicone oil, fluorine-containing compounds, and the like.

Plasticizers having a relatively low molecular weight can also be used. The molecular weight of the plasticizer is preferably lower than that of a resin to be plasticized. The molecular weight is preferably 15000 or less, and more preferably 8000 or less.

Polymer plasticizers can also be used. In this case, those of the same kind with the resin to be plasticized are preferred. For example, polyesters are preferably used for plasticizing a polyester resin. In addition, oligomers can be used as the plasticizer.

In addition to the aforementioned plasticizer, the plasticizers are also available under the trade names of Adekacizer PN-170 and PN-1430 from Asahi Denka Kogyo Co., Ltd.; PARAPLEX G-25, G-30 and G40 from C. P. Hall Co.; Ester Gum 8L-JA, Ester R-95, Pentalin 4851, FK 115, FK 4820 and FK 830, Luisol 28-JA, Picolastic A75, Picotex LC and Crystalex 3085 from Rika Hercules Co.

The plasticizer is added to at least one of a layer in a layer-structure including the toner image-receiving layer disposed on the support. The layer-structure includes a protective layer, an intermediate layer and an undercoat. The layer to which the plasticizer is added is preferably the one which receives stress generated when the toner is embedded in the toner image-receiving layer. More preferably, the layer is the one which receives strain due to the stress. Such strain includes, for example, physical strain such as elastic force and viscosity, and strain due to material balance in, for example, molecules, principle chains and/or pendant moieties of the binder. The layer is particularly preferably the one adjacent to the toner image-receiving layer, for example, the toner image-receiving layer itself and/or a surface layer, all of which can mitigate the stress and/or strain.

The plasticizer may be finely dispersed, may undergo micro-phase separation into islands-in-sea form or may be sufficiently dissolved or miscible with other components such as a binder in the layers.

The amount of the plasticizer is preferably from 0.001% by mass to 50% by mass, more preferably from 0.1% by mass to 50% by mass, and still more preferably from 1% by mass to 25% by mass based on the total mass of the resin, the plasticizer, and other components in the layer.

The plasticizers can be used to control the slipping property leading to the improvement in the transport performance due to friction reduction, improve the anti-offset property during fixing (separation of toner or layers onto the fixing means) or control the curling property and the charging property for a desirable latent toner image formation.

Fillers

The fillers can be any of known reinforcers, filling agents, and reinforcements for resins and are preferably organic and inorganic fillers.

The fillers can be selected with reference to, for example, Compounding Ingredients for Rubbers and Plastics, Revised 2nd Ed., Rubber Digest Co., 1993; Compounding Agents for Plastics, Basis and Applications, New Edition, Taiseisha; and Filler Handbook, Taiseisha.

The fillers can be, for example, any of inorganic pigments such as titanium oxide, calcium carbonate, silica, talc, mica, alumina, or the like, described in Compounding Ingredients for Rubbers and Plastics, Revised 2nd Ed., Rubber Digest Co., 1993.

Matting Agent

The matting agents are not specifically limited, and can be appropriately selected according to an intended purpose. Examples of the matting agents include solid particles.

The solid particles can be classified into inorganic particles and organic particles.

The inorganic particles are made of an inorganic substance such as oxides (e.g., silicon dioxide, titanium oxide, magnesium oxide, and aluminum oxide), alkaline earth metal salts (e.g., barium sulfate, calcium carbonate, and magnesium sulfate), glass, and the like.

Examples of the inorganic matting agents can be found in West German Patent No. 2,529,321, UK Patent No. 760,775, and No. 1,260,772, and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245, 4,029,504, and the like.

The organic particles are made of an organic substance such as starch, cellulose esters (e.g., cellulose acetate propionate), cellulose ethers (e.g., ethyl cellulose), a synthetic resin, or the like.

The synthetic resins are preferably insoluble or difficult to become soluble in water. Examples of the synthetic resin include poly(meth)acrylic esters such as poly(alkyl (meth)acrylate), poly(alkoxyalkyl (meth)acrylate), poly(glycidyl (meth)acrylate), or the like; poly(meth)acrylamides; polyvinyl esters such as poly(vinyl acetate); polyacrylonitriles; polyolefins such as polyethylenes; polystyrenes; benzoguanamine resins; formaldehyde condensation polymers; epoxy resins; polyamides; polycarbonates; phenol resins; poly(vinyl carbazole)s; poly(vinylidene chloride), and the like.

The organic particles can be made of a copolymer comprising two or more repeated units contained in the above-mentioned polymers. The copolymer can contain a small amount of hydrophilic repeated units derived from hydrophilic monomers. Examples of the hydrophilic monomers include acrylic acid, methacrylic acid, α,β-unsaturated dicarboxylic acid, hydroxyalkyl (meth)acrylate, sulfoalkyl (meth)acrylate, styrenesulfonic acid, and the like.

Organic particles as matting agents are described in UK Patent No. 1,055,713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924, and No. 3,767,448, JP-A No.49-106821, U.S. Pat. No. 57-14835, or the like.

Each of these solid particles can be used either alone or in combination of two or more.

The matting agent has a specific gravity of preferably 2 or less, more preferably 1.6 or less, and still more preferably 1.3 or less.

The amount of the matting agent is preferably 0.01 g/m² to 0.5 g/m², and more preferably 0.02 g/m² to 0.3 g/m².

Crosslinking Agents

Examples of the crosslinking agents include compounds each having two or more reactive groups in their molecule. Examples of the reactive group include epoxy group, isocyanate group, aldehyde group, active halogen groups, active methylene group, acetylene group, and the like. The examples of the crosslinking agents also include compounds each having two or more groups that can form a bond such as hydrogen bond, ionic bond, and coordinate bond.

The crosslinking agents also include conventional compounds known as coupling agents, curing agents, polymerization agents, polymerization accelerators, solidifying agents, film-forming agents, and film-forming aids, each of which is for resins. Examples of the coupling agents include chlorosilanes, vinylsilanes, epoxysilanes, aminosilanes, alkoxyaluminum chelates, and titanate coupling agents, as well as any known coupling agents as described in, for example, Handbook on Compounding Ingredients for Rubbers and Plastics, edited by Rubber Digest Co.

Charge Control Agents

The charge control agents can be used for controlling transfer and deposition of the toner, and for preventing adhesion between the electrophotographic image-receiving sheets due to charging. The charge control agents can be any of conventional antistatic agents and charge control agents, such as cationic surfactants, anionic surfactants, amphoteric surfactants, nonionic surfactants, and other surfactants, as well as polymer electrolytes, conductive metal oxides, and the like.

Examples of the charge control agents include quaternary ammonium salts, polyamine derivatives, cation-modified poly(methyl methacrylate), cation-modified polystyrenes, or the like; alkyl phosphates, anionic polymers, and other anionic charge control agents; and fatty acid esters, polyethylene oxides, and other nonionic charge control agents.

When the toner has negative charges, the charge control agents are preferably cationic or nonionic charge control agents.

Conductive Agents

Examples of the conductive agents include metal oxides such as ZnO, TiO₂, SnO₂, Al₂O₃, In₂O₃, SiO₂, MgO, BaO, MoO₃, or the like. Each of these metal oxides can be used either alone or in combination of two or more. The metal oxides may further comprise another element of different type. For example, ZnO may be contained in Al or In. TiO₂ may be contained in (doped with) Nb or Ta. SnO₂ may be doped with Sb, Nb, or a halogen atom.

The surface on which an image is formed of the electrophotographic image-receiving sheet of the present invention preferably has a high smoothness. Specifically, the surface on which an image is formed has a surface roughness (Ra) of preferably 3 μm or less, more preferably 1 μm or less, and still more preferably 0.5 μm or less in all the regions ranging from white without toner to black of the maximum density.

The surface roughness can be determined according to JIS B 0601, B 0651, and B 0652.

The toner image-receiving layer and the other layers preferably have a surface electric resistance in a range from 1×10⁶ to 1×10¹⁵ Ω at 25° C. and 65% RH.

If the surface electric resistance is less than 1×10⁶ Ω, the toner may not be transferred to the toner image-receiving layer in a sufficient amount to thereby decrease the density of the resulting toner image. If it is more than 1×10¹⁵ Ω, the toner may not sufficiently be transferred due to excessive charges generated during transfer to thereby decrease the density of the resulting image. In addition, the electrophotographic image-receiving sheet may build up static during its handling to thereby invite deposition of dust and to invite misfeeding, double feeding, discharge mark, and toner omission on an image during transfer.

When the electrophotographic image-receiving sheet is a transmitting image-receiving sheet comprising the toner image-receiving layer and other layers disposed on a transparent support, each of the layers disposed on the support is preferably transparent. When the electrophotographic image-receiving sheet is a reflective image-receiving sheet comprising the toner image-receiving layer and other layers disposed on a reflective support, each of the layers on the support does not need to be transparent and is rather preferably white.

The whiteness of the electrophotographic image-receiving sheet is preferably 85% or more as measured by a method specified in JIS P 8123. More specifically, it is preferred that the spectral reflectance of the electrophotographic image-receiving sheet is 85% or more and the difference between the maximum spectral reflectance and the minimum spectral reflectance is 5% or less at wavelength of 440 nm to 640 nm. It is more preferred that the spectral reflectance of the electrophotographic image-receiving sheet is 85% or more and the difference between the maximum spectral reflectance and the minimum spectral reflectance is 5% or less at wavelength of 400 nm to 700 nm.

When the toner image-receiving layer is transparent, the optimum surface electric resistance of the toner image-receiving layer is about 1×10¹⁰ Ω/cm² to about 1×10¹³ Ω/cm², and is preferably about 5×10¹⁰ Ω/cm² to about 5×10¹² Ω/cm². The amount of the antistatic agent can be determined depending on this parameter.

The surface electric resistance of the opposite surface of the support to the toner image-receiving layer is generally from about 5×10⁸ Ω/cm² to 3.2×10¹⁰ Ω/cm², and is preferably from about 1×10⁹ Ω/cm² to about 1×10¹⁰ Ω/cm². The surface electric resistance can be measured according to JIS K 6911 by conditioning a sample at a temperature of 20° C. and a humidity of 65% for 8 hours or longer, applying a voltage to the sample at 100 V for 1 minute under the same conditions, and measuring the surface electric resistance of the sample using an electrometer R 8340 available from Advantest Corporation.

The electrophotographic image-receiving sheet may further comprise a backing layer on the opposite surface of the support to the surface of the support on which the toner image-receiving layer is disposed.

When the electrophotographic image-receiving sheet is the transmitting, the backing layer is preferably transparent. When the electrophotographic image-receiving sheet is the reflective type, the backing layer is not necessarily transparent and can be of any color. When the electrophotographic image-receiving sheet is a double-sided type on which images are formed both on the upper and back surfaces, the backing layer is preferably white. The whiteness and the spectral reflectivity of the back surface are preferably 85% or more as in the upper surface.

When the electrophotographic image-receiving sheet is the reflective type, the opacity thereof is preferably 85% or more and more preferably 90% or more as measured according to a method specified in JIS P 8138.

The electrophotographic image-receiving sheet of the present invention may further comprise at least one surface protective layer on the surface of the toner image-receiving layer in order to protect the surface, to improve the storage stability, to improve the handleability, to impart writability to the sheet, to enable the sheet to be transported in an apparatus more smoothly, and to impart anti-offset properties to the sheet. The surface protective layer can have a single layer structure or a multilayer structure. The surface protective layer may comprise, as a binder, any of thermoplastic resins, thermosetting resins, and water-soluble polymers and preferably comprises a resin or polymer of the same type as that in the toner image-receiving layer. The thermodynamic properties, electrostatic properties, and other properties of the surface protective layer are not necessary to be the same as those of the toner image-receiving layer and can be optimized, respectively.

The surface protective layer may comprise any of additives which can be used in the toner image-receiving layer, of which charge control agents, matting agents, lubricants (slipping agents), and mold releasing agents are preferably used. These additives can also be used in other layers in addition to the surface protective layer.

The outermost surface (e.g., the surface protective layer) of the electrophotographic image-receiving sheet of the present invention is preferably sufficiently miscible or compatible with the toner for better fixing properties. More specifically, the contact angle between the outermost surface and a molten toner is preferably 0° to 40°.

The matting agents for use herein can be those for use in the toner image-receiving layer.

It is preferred that the electrophotographic image-receiving sheet of the present invention does not adhere to a fixing and heating member during a fixing procedure. Therefore, the 180-degree separation strength of the electrophotographic image-receiving sheet with the fixing member is preferably 0.1 N/25 mm or less, and more preferably 0.041 N/25 mm or less at fixing temperature. The 180-degree separation strength can be measured according to a method specified in JIS K 6887 using a surface material of the fixing member.

The lubricants (slipping agents) can be any of known lubricants such as sodium higher-alkylsulfates, higher fatty acid higher alcohol esters, Carbowax (trade mark), higher-alkyl phosphates, silicone compounds, modified silicone and curable silicones, as well as polyolefin wax, fluorine-containing oil, fluorine-containing wax, carnauba wax, microcrystalline wax, silane compounds, or the like.

Examples of the lubricants can be found in U.S. Pat. Nos. 2,882,157, 3,121,060, and 3,850,640, French Patent No. 2180465, UK Patent No. 955061, No. 1143118, No. 1263722, No. 1270578, No. 1320564, No. 1320757, No. 2588765, No. 2739891, No. 3018178, No. 3042522, No. 3080317, No. 3082087, No. 3121060, No. 3222178, No. 3295979, No. 3489567, No. 3516832, No. 3658573, No. 3679411, and No. 3870521, JP-A No. 49-5017, No. 51-141623, No. 54-159221, and No. 56-81841, and Research Disclosure No. 13,969.

In general, the amount of the lubricant is not specifically limited, can be appropriately selected according to an intended purpose and is preferably from 30 mg/m² to 3000 mg/m² and more preferably from 100 mg/m² to 1500 mg/m².

In oil-less fixing in which oil is not used for preventing offset to the fixing member in a fixing unit, the amount of the lubricant is preferably from 5 mg/m² to 500 mg/m², and more preferably from 10 mg/m² to 200 mg/m².

Among the lubricants, waxes are difficult to become dissolved in organic solvents and are preferably incorporated by preparing an aqueous dispersion of wax, then preparing a dispersion of the aqueous dispersion with a solution of the thermoplastic resin, and applying the dispersion. In this case, the wax lubricant is in the form of fine particles in the thermoplastic resin. The amount of the wax lubricant is preferably 5 mg/m² to 10000 mg/m², and more preferably from 50 mg/m² to 5000 mg/m².

The electrophotographic image-receiving sheet of the present invention may further comprise a contact improving layer to improve adhesion among the support, the toner image-receiving layer and the other layers.

The contact improving layer may comprise any of the aforementioned additives. Of those, the crosslinking agents are preferably used. The electrophotographic image-receiving sheet of the present invention may have a cushioning layer to enable the sheet to receive the toner more sufficiently. It may further comprise a moisture-barrier layer in order to make the sheet less dependent on ambient moisture during storage before, during printing or after printing.

In addition, the electrophotographic image-receiving sheet of the present invention may further have an intermediate layer in addition to the aforementioned layers.

The electrophotographic image-receiving sheet of the present invention may comprise any of additives in order to improve stability of output images and to improve stability of the toner image-receiving layer itself.

Examples of the additives include antioxidants, anti-aging agents, ultraviolet absorbents, metal complexes, light stabilizers, antidegradants, antiozonants, antiseptics, fungicides, and the like.

Examples of the antioxidants include chroman compounds, coumarane compounds, phenol compounds (e.g., hindered phenol), hydroquinone derivatives, hindered amine derivatives, spiro-indan compounds, and the like. Typical disclosure of the antioxidants can be found in, for example, JP-A No. 61-159644.

Examples of the anti-aging agents include those described in Handbook on Compounding Ingredients for Rubbers and Plastics, Revised Second Edition, pages 76-121, edited by Rubber Digest Co., 1993.

Examples of the ultraviolet absorbents include benzotriazole compounds (described in U.S. Pat. No. 3,533,794), 4-thiazolidone compounds (described in U.S. Pat. No. 3,352,681), benzophenone compounds (described in JP-A No. 46-2784) and ultraviolet absorbing polymers (described in JP-A No. 62-260152), and the like.

The metal complexes are described in U.S. Pat. Nos. 4,241,155, 4,245,018, and 4,254,195, and JP-A No. 61-88256, No. 62-174741, No. 63-199248, No. 01-75568, and No. 01-74272, and the like.

Preferable examples of the light stabilizers include those described in Handbook on Compounding Ingredients for Rubbers and Plastics, Revised Second Edition, pages 122-137, edited by Rubber Digest Co., 1993.

The electrophotographic image-receiving sheet of the present invention may further comprise any conventional or known additives for photography.

Typical disclosure of such additives for photography can be found in, for example, Research Disclosure (hereinafter briefly referred to as “RD”).No. 17643 (December, 1978), No. 18716 November, 1979), and No. 307105 (November 1989) as follows.

| | RD No. | RD No. | RD No. |
|---|---|---|---|
| Additives | 17643 | 18716 | 307105 |
| Whitening agents | pp. 24 | p. 648, right | p. 868 |
| | | column | |
| Stabilizers | pp. 24-25 | p. 649, right | pp. 868-870 |
| | | column | |
| Light absorbents (UV | pp. 25-26 | p. 649, right | p. 873 |
| absorbents) | | column | |
| Color image stabilizer | p. 25 | p. 650, right | p. 872 |
| | | column | |
| Hardening agents | p. 26 | p. 651, left | pp. 874-875 |
| | | column | |
| Binders | p. 26 | p. 651, left | pp. 873-874 |
| | | column | |
| Plasticizers, lubricants | p. 27 | p. 650, right | p. 876 |
| | | column | |
| Coating aids (surfactants) | pp. 26-27 | p. 650, right | pp. 875-876 |
| | | column | |
| Antistatic agents | p. 27 | p. 650, right | pp. 876-877 |
| | | column | |
| Matting agents | | | pp. 878-879 |

(Color Toners for Electrophotography)

Color toners for electrophotography for use in the present invention can be obtained by any process such as pulverization or suspension-granulation.

The color toners for electrophotography obtained by pulverization can be prepared by kneading, pulverization, and classification. Binder resins for use in manufacturing the color toners for electrophotography obtained by pulverization include, for example, resins obtained by polymerization of a monomer such as acrylic acid, methacrylic acid, maleic acid, other acids, and esters thereof; as well as polyesters; polysulfonates; polyethers; polyurethanes; and resins obtained by copolymerization of two or more of monomers contained in these resins. The color toner can be prepared by, for example, sufficiently kneading the binder resin, a wax component, and other toner materials in a heat kneader such as a heat roll, a kneader or an extruder, and mechanically pulverizing and classifying the kneaded product.

The content of the wax component in the color toner for electrophotography obtained by pulverization is preferably from 0.1% by mass to 10% by mass, and more preferably from 0.5% by mass to 7% by mass, based on the total mass of the toner.

The color toner for electrophotography obtained by suspension-granulation can be prepared in the following manner. Initially, a binder resin, a colorant, a mold releasing agent, as well as a magnetic material, a charge control agent, and other additives according to necessity are mixed in a solvent immiscible with water, the resulting composition is covered with a polymer having carboxyl groups, is dispersed in an aqueous medium in the presence of a hydrophilic inorganic dispersing agent with a BET specific surface area of 10 m²/g to 50 m²/g and/or a viscosity modifier, where necessary the resulting suspension is diluted with an aqueous medium, the solvent in the resulting suspension is then removed by heating and/or reducing pressure and thereby yields the color toner. The color toners for electrophotography obtained by suspension-granulation are more preferably used in the present invention, compared with those obtained by pulverization.

Binder resins for use in the color toner for electrophotography obtained by suspension-granulation can be any of known binder resins. Examples of such binder resins include homopolymers and copolymers of monomers. Specific examples of the homoploymers and copolymers include styrene such as chlorostyrene, or the like; ethylene, propylene, butylene, isoprene, and other monoolefins; vinyl acetate, vinyl propionate, vinyl benzoate, vinyl butyrate, and other vinyl esters; α-methylene aliphatic monocarboxylic esters such as methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate, or the like; vinyl ethers such as vinyl methyl ether, vinyl ethyl ether, vinyl butyl ether, or the like; vinyl ketones such as vinyl methyl ketone, vinyl hexyl ketone, vinyl isopropenyl ketone, or the like. Specific examples of the binder resins include polystyrene resins, polyester resins, styrene-alkyl acrylate copolymers, styrene-alkyl methacrylate copolymers, styrene-acrylonitrile copolymers, styrene-butadiene copolymers, styrene-maleic anhydride copolymers, polyethylene resins, polypropylene resins, as well as polyurethane resins, epoxy resins, silicone resins, polyamide resins, modified rosins, paraffins, wax, and the like. Of these, styrene-acrylic resins are preferred.

Colorants for use in the binder resin can be any of conventional or known colorants. Examples of the colorants include carbon black, nigrosine dyes, Aniline Blue, Chalcoyl Blue, Chrome Yellow, Ultramarine Blue, Du Pont Oil Red, Quinoline Yellow, Methylene Blue Chloride, Phthalocyanine Blue, Malachite Green oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1, C.I. Pigment Blue 15:3, and the like.

The content of the colorant is preferably 2% by mass to 8% by mass. If the content of the colorant is less than 2% by mass, the color toner for electrophotography may have insufficient coloring capability. If it is more than 8% by mass, the toner may have deteriorated transparency.

The color toner for electrophotography may preferably comprise a mold releasing agent. Wax is preferably used as such mold releasing agents. Specific examples of the mold releasing agent include low molecular weight polyolefins such as polyethylene, polypropylene, polybutene, or the like; silicone resins and aliphatic amides such as oleamide, erucamide, ricinoleamide, and stearamide, which can be softened by heat; vegetable wax such as carnauba wax, rice bran wax, candelilla wax, Japan wax, jojoba oil, or the like; animal wax such as bees wax, or the like; mineral or petroleum wax such as montan wax, ozokerite, ceresin, paraffin wax, microcrystalline wax, Fischer-Tropsch wax, or the like; and modified products of these wax, and the like. Of these, those having high polarity, such as carnauba wax and candelilla wax, are apt to be exposed on a surface of the toner. In contrast, those having low polarity, such as polyethylene wax and paraffin wax, are apt to be less exposed on the surface of the toner. The melting point of the wax is preferably from 30° C. to 150° C., and more preferably from 40° C. to 140° C., regardless of such tendency to be exposed to the surface.

The color toner for electrophotography mainly comprises the colorant and the binder resin. The average particle diameter of the toner is about 3 μm to about 15 μm, and preferably about 4 μm to about 8 μm. The storage modulus (G′) of the color toner for electrophotography itself is preferably 10 Pa to 200 Pa as measured at an angular frequency of 10 rad/sec.

The color toner for electrophotography may comprise external additive. Examples of the external additives include fine particles of inorganic compounds, and fine particles of organic compounds.

Such fine particles of inorganic compounds are made of, for example, SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, or the like.

Examples of the fine particles of organic compounds include fine particles of aliphatic acids, derivatives thereof, and metal salts thereof, and fine particles of resins such as fluorine-containing resins, polyethylene resins, acrylic resins, or the like.

(Process for Image Formation)

The process for image formation of the present invention uses the electrophotographic image-receiving sheet of the present invention and includes the step of forming a toner image on a surface of an electrophotographic image-receiving sheet, the step of heating and pressurizing the surface by a fixing belt and a fixing roller, and the step of cooling the surface so as to separate the electrophotographic image-receiving sheet from the fixing belt.

The process for image formation can be performed using a conventional or known an apparatus for image formation of electrophotography.

The apparatus for image formation for use herein comprise a transport unit for transporting the electrophotographic image-receiving sheet, a latent electrostatic image forming unit, a development unit arranged in the vicinity of the latent electrostatic image forming unit, and a fixing unit. The apparatus for image formation may have an intermediate image transfer unit at the center of the apparatus, which is in the vicinity of the latent electrostatic image forming unit and the transport unit.

In contrast to a process in which a toner image formed on a development roller is directly transferred onto an electrophotographic image-receiving sheet, the intermediate image transfer unit is used in an apparatus of transfer system using an intermediate belt, in which a toner image is primarily transferred onto an intermediate belt and is then secondarily transferred onto an electrophotographic image-receiving sheet. The transfer system using the intermediate belt is preferably employed for sufficient environmental stability and higher image quality.

An adhesive transfer system or a heat-aided transfer system instead of, or in combination with, electrostatic transfer or bias roller transfer has been known. Specific configurations of these systems can be found in, for example, JP-A No. 63-113576 and JP-A No. 05-341666. A method using an intermediate image transfer belt according to the heat-aided transfer system is preferred when a color toner for electrophotography having a small average particle diameter of 7 μm or less. The intermediate image transfer belt can be, for example, an endless belt made of an electrocast nickel having a silicone or fluorine-containing thin film on its surface and thereby having releasing capability. The intermediate image transfer belt preferably has a cooling device in a portion after transfer procedure or in a latter half of transfer procedure of the toner to the electrophotographic image-receiving sheet.

By action of the cooling device, the toner for electrophotography can be cooled to one of the softening point or lower and glass transition temperature of the binder resin or lower, and can be efficiently separated off from the intermediate image transfer belt and transferred onto the electrophotographic image-receiving sheet.

The fixing step is an important step that control glossiness and smoothness of the resulting images. The fixing step includes, for example, a fixing step using a hot pressing roller, and a belt-fixing step using a belt. For better image quality such as the glossiness and smoothness, the belt fixing step is preferred.

Typical disclosure of the belt fixing step can be found in, for example, JP-A No. 11-352819 using an oil-less belt, and in JP-A No. 11-231671 and No. 05-341666 in which secondary transfer and fixing are performed at the same time.

To improve the releasing property of the toner or to prevent off-set of the toners, the surface of a fixing belt for use in the belt fixing process has been preferably subjected to a surface treatment with a coupling agent (surface treatment agent) such as silicone coupling agent, fluorine-containing coupling agent and a combination of these agents. It is also preferred that the latter half of the fixing step has a cooling device for the fixing belt to thereby enhance the separation of the electrophotographic image-receiving sheet.

The fixing belt is cooled by the cooling device to one of the softening point of the binder resin or lower and the glass transition point of the binder resin in the toner for electrophotography and/or of the thermoplastic resin used in the toner image-receiving layer or lower. During the early stages of the fixing step, the temperature is required to be raised to such a temperature that the toner image-receiving layer in the electrophotographic image-receiving sheet or the toner for electrophotography becomes sufficiently softened. More specifically, the fixing belt is preferably cooled to 30° C. to 70° C. The temperature during the early stages of the fixing step is more preferably from 100° C. to 180° C.

The present invention will be described in further detail with reference to several examples and comparative examples below, which are not intended to limit the scope of the present invention.

“%” and “part(s)” in the examples and comparative examples are each referred to as “% by mass” and “part(s) by mass.”

### EXAMPLE 1

Preparation of Support A

Broad-leaved (hardwood) bleached kraft pulp (LBKP) was beaten to a Canadian standard freeness (CSF) of 300 ml using a disk refiner, and was adjusted so as to have a fiber length of 0.58 mm. The following additives were added to the pulp stock in proportions shown below based on the mass of the pulp.

| Additive | Amount (%) |
|---|---|
| Cationic starch | 1.2 |
| Alkyl ketene dimer (AKD) | 0.5 |
| Anionic polyacrylamide | 0.3 |
| Epoxidized fatty acid amide (EFA) | 0.2 |
| Polyamide-polyamine-epichlorohydrin | 0.3 |

* In the alkyl ketene dimer (AKD), the alkyl moiety is derived from fatty acids mainly containing behenic acid. In the epoxidized fatty acid amide (EFA), the fatty acid moiety is derived from fatty acids mainly containing behenic acid.

Raw paper having a basis weight of 150 g/m² was then made from the resulting pulp stock using a Fourdrinier paper machine. In this process, 1.0 g/m² of polyvinyl alcohol (PVA) and 0.8 g/m² of CaCl₂ were added to the raw paper at some midpoint in a drying zone of the Fourdrinier paper machine using a size press device.

At the end of the paper making process, the density of the raw paper was adjusted to 1.01 g/cm³ using a soft calendering machine. The resulting raw paper was allowed to pass through a metal roll at a surface temperature of 140° C. or higher, so that a surface on which a toner image-receiving layer was formed, was brought into contact with the metal roll. Thus, a support A was prepared.

Preparation of Coating Solution for Backing Layer

The following components were mixed, stirred and thereby yielded a coating solution for a backing layer.

| | | |
|---|---|---|
| Hiros XBH-997L (solids 30%) | 100.0 | parts |
| (Seiko Chemical Industries Co., Ltd.) | | |
| Techpolymer MBX-12 (Sekisui Plastics Co., Ltd.) | 5.0 | parts |
| Hydrin D337 (Chukyo Yushi Co., Ltd.) | 10.0 | parts |
| CMC Daicel 1380 (1%) | 10.0 | parts |
| (Daicel Chemical Industries, Ltd.) | | |
| Sodium dodecylbenzenesulfonate (5%) | 1.0 | part |
| Ion-exchanged water | 80 | parts |

<Application of Backing Layer>

The above-prepared coating solution for the backing layer was applied in a dry mass of 9 g/m² to the back surface of the support A using a bar coater. The surface roughness (Ra) of the resulting backing layer was 2.3 μm.

Formation of Toner Image-receiving Layer

A coating solution for a toner image-receiving layer having the following composition was prepared. The coating solution was applied in a dry mass of 15 g/m² to the upper surface of the support A after forming the backing layer using a bar coater, was dried and thereby yielded a toner image-receiving layer.

Coating solution for toner image-receiving layer

| | | |
|---|---|---|
| Elitel KZA-1449 (solids 30%) (Unitika Ltd.) | 100 | parts |
| Cellosol 524F (solids 30%) (Chukyo Yushi Co., Ltd.) | 5 | parts |
| Nissan Rapisol B-90 (NOF Corporation) | 1 | part |
| Titanium oxide dispersion (solids 45%) | 15 | parts |
| Ion-exchanged water | 100 | parts |

The composition of the titanium oxide dispersion is as follows.

| | |
|---|---|
| Titanium oxide (R-7802; Ishihara Sangyo Kaisha, Ltd.) | 40% |
| Poly(vinyl alcohol) (PVA205; Kuraray Co., Ltd.) | 5% |
| DEMOL EP (Kao Corporation) | 0.125% |

### EXAMPLE 2

An electrophotographic image-receiving sheet was prepared in the same way as in EXAMPLE 1, except that 3 parts of FLO-BEADS CL-2080 (available from Sumitomo Seika Chemical Co., Ltd.; average particle diameter: 12 μm, melting point: 105° C.) was added to the coating solution for the toner image-receiving layer.

### EXAMPLE 3

An electrophotographic image-receiving sheet was prepared in the same way as in EXAMPLE 1, except that 5% of FLO-BEADS CL-2080 (available from Sumitomo Seika Chemical Co., Ltd.; average particle diameter: 12 μm, melting point: 105° C.) was used instead of the titanium oxide dispersion in the coating solution for the toner image-receiving layer.

### COMPARATIVE EXAMPLE 1

An electrophotographic image-receiving sheet was prepared in the same way as in EXAMPLE 1, except that the titanium oxide dispersion was not used.

### EXAMPLES 4 to 6

Electrophotographic image-receiving sheets were prepared in the same way as in EXAMPLEs 1 to 3, respectively, except that a cast coat paper (Mirrorcoat Platina available from Oji Paper Co., Ltd.) having a basis weight of 186 g/m² was used instead of the support A.

### EXAMPLES 7 to 9

Electrophotographic image-receiving sheets were prepared in the same way as in EXAMPLEs 1 to 3, respectively, except that laminated paper obtained by laminating polyethylene (low density polyethylene, LDPE) to a thickness of 20 μm on both of the surfaces of the support A was used, and that the surface of the laminated paper was subjected to corona discharge treatment before applying the coating solution for the toner image-receiving layer.

### COMPARATIVE EXAMPLES 2 and 3

Electrophotographic image-receiving sheets were prepared in the same way as in EXAMPLEs 4 and 7, except that the titanium oxide dispersion was not used.

### Comparative Examples 4, 5 and 6

Electrophotographic image-receiving sheets were prepared in the same way as in EXAMPLEs 1, 4, and 7, respectively, except that the matting agent was not used in the backing layer of the support.

<Evaluation Methods>

The following properties (1), (2), (3), (4), and (5) of the electrophotographic image-receiving sheets were used for evaluation. The results are shown in Tables 1 and 2.

(1) Adhesion Resistance (Anti-blocking Properties)

An unprinted sample was conditioned at 25° C. and 80% relative humidity (RH) for 24 hours, and two plies of the conditioned sample were stacked so that the upper surface faced the back surface. The stacked sample was left to stand at 30° C. and 80% RH for 7 days while applying a 500 g load to a 3.5 cm square area. The two plies of the sample were then separated from each other. In this procedure, the adhesion resistance was rated according to the following criteria.

Criteria

⊚: No separation sound or adhesion mark.

◯: Some separation sound but no adhesion mark.

Δ: Some adhesion mark (less than one fourth in the area of the sheet).

X: One fourth or more of adhesion mark in the area.

A test image was printed on each of the above-prepared electrophotographic image-receiving sheets using a color laser printer DocuColor 1250PF (available from Fuji Xerox Co., Ltd.). Some of the printed electrophotographic image-receiving sheets were further subjected to fixing using a fixing belt system 1 shown in FIGURE. The fixing belt system 1 includes a fixing belt 2 spanned around a heating roller 3 and a tension roller 5. The tension roller 5 is arranged above a cleaning roller 6 via the fixing belt 2. The heating roller 3 is arranged below a press roller 4 via the fixing belt 2. The electrophotographic image-receiving sheet bearing a latent toner image was inserted into between the heating roller 3 and the press roller 4 from the left side in FIGURE, was fixed by heating and pressurizing, was transported with disposed the fixing belt 2 and was cooled by a cooling device 7 which is arranged along downstream of the fixing belt 2. The electrophotographic image-receiving sheet was separated from the fixing belt 2, and the fixing belt passed around the tension roller 5 and was cleaned by the cleaning roller 6.

In the fixing belt system, the transport speed of the fixing belt 2 was 30 mm/sec, the nip pressure between the heating roller 3 and the press roller 4 was 0.2 MPa (2 kgf/cm²), and the temperature of the heating roller 3 corresponding to fixing temperature was set at 150° C. The temperature of the press roller 4 was set at 120° C.

(2) Evaluation of Image Quality

Each of the prepared electrophotographic image-receiving sheets was cut to A4 size (210 mm×297 mm). A portrait image of a woman was printed on the cut sheet using the DocuColor 1250PF, and some of the printed sheets were further subjected to the belt fixing procedure as above. The image quality of the printed sheets and the image-fixed sheets was rated according to the following criteria.

Criteria

◯: Among 30 personals, 25 or more personals assessed the printed image to be photographically preferable.

Δ: Among 30 personals, 20 or more personals assessed the printed image to be photographically preferable.

X: Among 30 personals, less than 20 personals assessed the printed image to be photographically preferable.

(3) Glossiness by specular reflection on a surface on which an image is formed at an angle of incidence of 20° between incident light and the electrophotographic image-receiving sheet

The glossiness of an unprinted sample, printed samples with three levels of density ranging from white to black solid image, and image-fixed samples were evaluated using a digital variable gloss meter UGV-5D (trade name, available from Suga Test Instruments Co., Ltd; glossiness by specular reflection on a surface on which an image is formed at an angle of incidence of 20° between incident light and the electrophotographic image-receiving sheet) using light coming in at an angle of incidence of 20° and being specularly reflected. Five-point averages at individual image densities were evaluated, and the minimum of the averages was defined as the glossiness.

(4) Transportability

A total of 20 sheets of each of the prepared electrophotographic image-receiving sheets were subjected to printing, and the transportability in this procedure was rated according to the following criteria.

Criteria

◯: No sheet undergoes double-feeding or misfeeding.

Δ: One to four sheets undergo double-feeding or misfeeding.

X: Five or more sheets undergo double-feeding or misfeeding.

(5) Surface Roughness (Ra)

The surface roughness (Ra) of an opposite surface of the electrophotographic image-receiving sheet to the surface on which the toner image-receiving layer was disposed (backing layer) for each of the prepared electrophotographic image-receiving sheets, was measured according to JIS B 0601.

TABLE 1

| | EXAMPLEs | | | | | | | | |
|---|---|---|---|---|---|---|---|---|---|
| | 1 | 2 | 3 | 4 | 5 | 6 | 7 | 8 | 9 |
| Support | Raw paper | | | Cast coated | | | PE laminated | | |
| | paper | | | paper | | | | | |
| Backing layer surface | 2.6 | 2.6 | 2.6 | 1.9 | 1.9 | 1.9 | 1.1 | 1.1 | 1.1 |
| roughness (Ra: μm) | | | | | | | | | |
| Glossiness | | | | | | | | | |
| Unprinted sample | 12 | 5 | 11 | 15 | 8 | 12 | 19 | 11 | 16 |
| After printing | 51 | 53 | 60 | 53 | 57 | 63 | 58 | 60 | 66 |
| After fixing | 62 | 64 | 69 | 68 | 70 | 74 | 69 | 73 | 80 |
| Adhesion resistance | ⊚ | ⊚ | ⊚ | ◯ | ⊚ | ⊚ | ◯ | ⊚ | ◯ |
| Transportability | ◯ | ◯ | ◯ | ◯ | ◯ | ◯ | ◯ | ◯ | ◯ |
| Image quality | | | | | | | | | |
| After printing | Δ | Δ | ◯ | Δ | ◯ | ◯ | ◯ | ◯ | ◯ |
| After fixing | ◯ | ◯ | ◯ | ◯ | ◯ | ◯ | ◯ | ◯ | ◯ |

TABLE 2

| | COMPARATIVE EXAMPLEs | | | | | |
|---|---|---|---|---|---|---|
| | 1 | 2 | 3 | 4 | 5 | 6 |
| Support | Raw | Cast coat | PE | Raw | Cast coat | PE |
| | paper | paper | laminated paper | paper | paper | laminated paper |
| Backing layer surface | 2.6 | 1.9 | 1.1 | 0.46 | 0.38 | 0.20 |
| roughness (Ra: μm) | | | | | | |
| Glossiness | | | | | | |
| Unprinted sample | 23 | 26 | 34 | 23 | 26 | 34 |
| After printing | 58 | 61 | 63 | 50 | 56 | 58 |
| After fixing | 63 | 69 | 71 | 62 | 69 | 66 |
| Adhesion resistance | X | X | X | X | X | X |
| Transportability | ◯ | Δ | Δ | Δ | Δ | X |
| Image quality | | | | | | |
| After printing | ◯ | ◯ | ◯ | Δ | ◯ | ◯ |
| After fixing | ◯ | ◯ | ◯ | ◯ | ◯ | ◯ |

As shown in the Tables 1 and 2, in the COMPARATIVE EXAMPLEs 1 to 6, a surface of the toner image-receiving layer of the electrophotographic image-receiving sheet has a glossiness by specular reflection is more than 20 before image formation at an angle of incidence of 20° between the electrophotographic image-receiving sheet and incident light. Accordingly, the electrophotographic image-receiving sheets of the COMPARATIVE EXAMPLEs 1 to 6 exhibit significantly deteriorated anti-adhesion properties (blocking properties), compared to those of the EXAMPLEs 1 to 9. It is therefore found out that the electrophotographic image-receiving sheets of the COMPARATIVE EXAMPLEs 1 to 9 are deteriorated in comprehensive evaluation results including transporting properties and image quality.

The present invention can provide electrophotographic image-receiving sheets which have excellent smoothness (glossiness), can be used for photography, do not invite adhesion between sheets and blocking among stacked plural plies thereof during storage, have excellent transportability, and show excellent comprehensive evaluation results.

1-13. (canceled)

14. A process for image formation comprising the steps of:
forming a toner image on a surface of an electrophotographic image-receiving sheet;
heating and pressurizing the surface by a fixing belt and a fixing roller; and
cooling the surface so as to separate the electrophotographic image-receiving sheet from the fixing belt,
wherein the electrophotographic image-receiving sheet comprises:
a support; and
a toner image-receiving layer which contains a thermoplastic resin and is disposed on the support,
wherein a surface of the toner image-receiving layer has a glossiness by specular reflection of 20 or less before image formation at an angle of incidence of 20° between the electrophotographic image-receiving sheet and incident light, and the surface has a glossiness by specular reflection of 50 or more after image formation at an angle of incidence of 20° between the electrophotographic image-receiving sheet and incident light.

15. A process for image formation according to claim 14, wherein the step of cooling is carried out by cooling the electrophotographic image-receiving sheet to one of a softening point of the thermoplastic resin or lower, and a glass transition temperature of the thermoplastic resin or lower.

16. A process for image formation according to claim 14, wherein a surface of the fixing belt is treated with one of a silicone coupling agent and a fluorine-containing coupling agent.

17. A process for image formation according to claim 14, wherein the thermoplastic resin is selected from the group consisting of a polyester resin, a styrene resin, and a styrene-butyl acrylate resin.

18. A process for image formation according to claim 14, wherein the toner image-receiving layer further comprises at least one of water-soluble resins and water-dispersible resins.

19. A process for image formation according to claim 14, wherein the toner image-receiving layer has a thickness of 0.5 μm to 50 μm.

20. A process for image formation according to claim 14, wherein an opposite surface of the support to a surface of the support on which the toner image-receiving layer is disposed has a surface roughness (Ra) of 0.5 μm or more.

21. A process for image formation according to claim 14, wherein the toner image-receiving layer further contains a water-dispersible polyester, carnauba wax, surfactants and polyethylene particles.
